(19) United States
(12) Patent Application Publication
(10) Pub. No.: US 2026/0106771 A1
(43) Pub. Date: Apr. 16, 2026

(54) IDENTIFYING MEETING PARTICIPANTS IN A REMOTE CONFERENCE

(71) Applicant: Avaya Management L.P., Morristown, NJ (US)

(72) Inventors: Paul Roller Michaelis, Louisville, CO (US); Amey Kulkarni, Pune (IN); Jaydeep Deepak Bhalerao, Pune (IN); Christopher D. Baldwin, Princeton, NJ (US); Sudhir Nivrutti Shelke, Pune (IN); Abhay Bhupal Chougule, Pune (IN); Dinesh Sonawane, Pune (IN)

(21) Appl. No.: 18/915,783

(22) Filed: Oct. 15, 2024

(51) Int. Cl. H04L 12/18; G01S 13/46; G10L 15/26; H04W 4/029; H04W 4/80

(52) U.S. Cl. CPC H04L 12/1822; G01S 13/46; G10L 15/26; H04L 12/1831; H04W 4/029; H04W 4/80; G01S 2013/468

(57) ABSTRACT

Identifying conference participants of a conference is often difficult when two or more conference participants share one conference endpoint. A participant receiving the conference may be unable to identify the participants and/or unable to identify a currently speaking participant. Systems and methods herein are provided to identify participants by image identification. Systems and methods herein are provided to identify a speaking participant by receiving a signal from a user device associated with the currently speaking participant. Systems and methods herein are provided to utilize a user device to communicate with an endpoint engaged in a communication with another endpoint, such as an emergency service provider.

### FIELD OF THE DISCLOSURE

The invention relates generally to systems and methods for participant identification in a conference and particularly to utilizing user devices to identify a current speaker or a location of a caller and/or visually identify participants from a group of conference participants.

### BACKGROUND

Remote conferences often utilize single endpoints to connect individuals and groups. Prior art systems allow the use of conferencing client/host login or account information to determine the identity of a single individual using a single device to participate in a remote conference. Identifying a speaking individual from a group of participants using a shared endpoint is either not possible or requires multiple microphones. The multiple microphones provide a relative strength of signal to determine a relative location of the source of the speech. If one of the individuals is present at that location, then they are identified as the speaker. However this requires the microphones to be tuned to the room and properly oriented.

Similarly, when an individual is the sole user of an endpoint and begins speaking, prior art systems can identify the speaker and highlight or otherwise point out the specific individual that is currently speaking. However, here too, it is often difficult to tell which individual, from a plurality of individuals, is speaking when the plurality of individuals is sharing an endpoint. Viewers of a video stream may be able to see a video stream portion of the conference and detect who is speaking through video cues (e.g., moving lips, gesturing, etc.). However, this is often insufficient when there is no video stream portion being presented to all of the other participants or the video image lacks sufficient detail. The detail, even when high-quality video streaming is utilized, may still be insufficient to allow viewers of the video portion to see who is speaking when there are participants not facing the camera or the field of view of the image is large.

### SUMMARY

When each individual in a teleconference has their own endpoint, teleconferencing systems such as Spaces™ or Teams™ are able to identify who is speaking and then present this information visually to others on the call. These systems do not identify who is speaking when multiple users share an endpoint, such as a speakerphone or microphone-equipped laptop computer in a conference room.

Solutions that require more than one microphone do not solve the problem addressed by the present invention, i.e., situations in which the endpoint in the shared location has only one microphone.

For video conferences with a plurality of participants sharing a common device (e.g., a conference room with video conferencing equipment), it is difficult to map the video of participants to a roster of attendees. The roster entries are often useful to identify participants and/or for sidebar communications (e.g., a quick chat, email, etc.). A conference room of multiple participants produces a single video stream containing images of the multiple participants. A roster for a multi-participant conference commonly includes a single entry, such as a host, manager, or meeting leader. As a result, identifying the participants individually is difficult or impossible without manual effort, such as asking for each participant to identify themselves, asking for a roster of participants, etc. Zoom™ meetings may utilize “room view” from one of two cameras and show individual participants separately. An identified speaker (who may or may not have a known identity) is shown and if/when identified, the speaker's name is identified and the speaker highlighted in the video stream. While useful, the “room view” approach requires multiple cameras.

The prior art solutions rely on complex acoustic analyses and/or multiple microphones and/or multiple cameras.

These and other needs are addressed by the various embodiments and configurations of the present invention. The present invention can provide a number of advantages depending on the particular configuration. These and other advantages will be apparent from the disclosure of the invention(s) contained herein.

The term “speaker” as used herein, refers to a human who is currently speaking (e.g., talking) or otherwise providing the audio portion of a conference at a particular time. The use of the term “speaker” herein shall not refer to an electro-mechanical device operable to generate sound waves from electrical signals. The use of an electro-mechanical device operable to generate sound waves from electrical signals shall be referred to herein as an “audio speaker.”

The term “remote” shall refer to a user (a/k/a “participant”) or endpoint, as the case may be, not physically present with the source of the audio and/or video portion of the conference. A remote user/endpoint is unable to hear/see at least one other participant in the meeting except by way of the networked endpoints.

The term “conference,” and forms thereof (e.g., remote conference, meeting, teleconference, etc.), as used herein, may be used interchangeably and shall refer to meetings comprising at least one endpoint operable to capture real-time signals via a signal capturing device (e.g., camera, microphone, transducer, etc.), having the captured signal converted for transmission over a network, and sending that signal over the network to at least one other endpoint operable to decode the signal for presentation by another remote endpoint as sound (e.g., audio stream) and/or images (e.g., video stream). In-person meetings between people, except when utilizing the networked endpoints to include one or more remote participants, shall not apply herein.

The term “user,” and forms thereof (e.g., participant and, when speaking, “speaker”) as used herein, may be used interchangeably to refer to an attendee of a conference. In certain embodiments, “user” and forms thereof, may refer to a non-attending invitee of a conference; a potential invitee to a conference, whether in attendance or not; and/or an invitee or attendee of a past conference.

In one embodiment, methods and systems are provided that allow for the use of existing conference and participant hardware, configured with software, to identify a speaker. The required hardware is likely already present at the shared location for a subset of conference participants (e.g., a laptop computer that supports Bluetooth and individually owned smartphones) to provide a reliable, low-cost solution to speaker identification.

The shared telecommunication endpoint will know who is speaking because it will receive from that person's smartphone a simple “the owner of this phone is speaking” Bluetooth message.

In another embodiment, individuals, such as those participating in a group conference, maybe identified individually.

When many people are participating in a teleconference and are sharing a single-microphone endpoint (e.g., when people are assembled in someone's office and are using the laptop in that office as a shared endpoint), the conference participants at other locations do not receive an indication about who is speaking at the shared location.

In one embodiment, a solution is provided that identifies a speaker from a group of potential speakers (e.g., conference participants at a common location). Prior to the start of the conference, participants at the shared location will pair their smartphones with the shared endpoint. As part of the pairing process, users will specify the name that will be displayed to others on the call when that user speaks.

Using techniques, such as automatic speaker verification, facial analyses, simple button presses, etc., each user's smartphone will “know” when the associated user of that device is speaking. When an individual at the shared location speaks, a Bluetooth signal from that person's smartphone to the shared endpoint will allow the shared endpoint to “know” who is speaking. The shared endpoint will transmit the identity information to others on the call. The user's individual device, such as a smartphone, is utilized solely to detect audio and report when the device's associated user is speaking via a signal, such as Bluetooth. The user's device is not used as an endpoint for the conference.

In another embodiment, the Bluetooth pairing process includes the smartphone providing to the local conference endpoint the image that the user wants the server to present when the user is speaking. Alternatively, the conference server could search a database for information about the identified user (such as a picture of the user), and then provide this information to others on the call.

In another embodiment, as part of the Bluetooth pairing process, a user's smartphone can provide location information to the endpoint. The endpoint can provide this information to others on the call. Additionally or alternatively, the location information may be provided to a 9-1-1 Public Safety Answering Point (PSAP) from a residential telephone. The PSAP can use the Caller ID information to identify the caller's exact location and then send help quickly to that location. When the PSAP receives a call from a cell phone, the PSAP can use cell tower triangulation, WiFi hubs, or other sources of radio frequency information, and/or global satellite positioning information to find the caller's location. But when an individual uses Workplace™ or similar application to call 9-1-1, the PSAP receives no information or can receive incorrect information regarding the caller's location unless the caller is able to tell them where they are (which many people are unable to do in an emergency). When the smartphone is able to identify its location, the proposed pairing mechanism and subsequent transmission of the location information could help ensure timely, appropriate responses to 9-1-1 calls made from Workplace™ or Workplace™-like endpoints.

In another embodiment, mapping participant from video stream to roster comprises identifying which participant's video is displayed in that clicked area selected by a user. The mapping may comprise utilization of a custom communication channel with the media server or backend server.

In another embodiment, depending on whether the incoming video stream is via Multipoint Conferencing Unit (MCU, composite stream) or Selective Forwarding Unit (SFU, multiple streams), the corresponding participant's data needs to be identified with the participants available in the roster. Once a matched participant is found in the roster, a highlight or pop-up is generated to identify the corresponding participant in the roster.

In another embodiment, multiple participants are attending from a single conference room, there is a single video stream and single roster entry. The number of participants in the video stream may be identifying, such as via existing identification means, to identify the participants utilizing a particular video endpoint. The backend server may then provide different participants a different form the video stream using the standard image and media processing algorithms.

In another embodiment, the individual participants are determined. An email or other invitation may comprise, or prompt to obtain, a profile pictures of the participant. The participants are then matched via the profile picture and the corresponding image in the video stream. In another embodiment, a search of a database\active directory is utilized to obtain images of the participants used for participant identification in a video stream.

In another embodiment, mapping participant from roster to video stream is performed. An option is provided, such as in a roster list, to identify the participant in the video stream. Participant information is sent to a media or backend server, such as via a custom communication channel. The media server or backend server identifies this participant's video stream and then highlights with a background or some user experience for the participant who requested the information. For scenarios where the participant has not spoken, remote participants may be provided with the option to obtain a video and/or information of the selected participant.

In some aspects, the techniques described herein relate to a conference server, including: a network interface to a network; and at least one processor coupled to a computer memory including instructions that, when read by the at least one processor, cause the at least one processor to perform: accessing a conference between a first endpoint and a second endpoint, the first endpoint being shared between a plurality of users wherein speech from any one or more of the plurality of users is received by the first endpoint, converted to electronic signals, and provided to the second endpoint as an audio portion of the conference; receiving a signal from the first endpoint identifying a user device, utilized by one of the plurality of users, and indicating speech has been detected from the one of the plurality of users; and in response to receiving the signal, inserting an identifier into the conference for presentation by the second endpoint.

In some aspects, the techniques described herein relate to a conference server, further including: a storage device; and wherein the instructions further cause the at least one processor to perform: appending a transcript of the conference with the identifier; and storing the appended transcript in the storage device.

In some aspects, the techniques described herein relate to a conference server, further including appending the transcript of the conference with the identifier and a timestamp of the occurrence of the signal.

In some aspects, the techniques described herein relate to a conference server, wherein inserting an identifier of the one of the plurality of users into the conference for presentation by the second endpoint includes generating speech including the identifier of the one of the plurality of users.

In some aspects, the techniques described herein relate to a conference server, wherein the instructions further cause the at least one processor to buffer the audio portion of the conference to accommodate presentation of the identifier by the second endpoint and, upon completion of the presentation of the identifier, resume presentation of the audio portion of the conference.

In some aspects, the techniques described herein relate to a conference server, wherein the network interface further includes a Bluetooth wireless interface and the signal further includes a Bluetooth signal.

In some aspects, the techniques described herein relate to a communication endpoint, including: a first network interface to a first network; a second network interface to a second network; and at least one processor coupled to a computer memory including instructions that, when read by the at least one processor, cause the at least one processor to perform: initiating, in response to an input from a user, a first communication via the first network to a second endpoint; receiving, via the second network interface, a location of a communication device associated with the user; and encoding the location for inclusion in the first communication for presentation by the second endpoint.

In some aspects, the techniques described herein relate to a communication endpoint, wherein receiving the location of the communication device associated with the user further includes receiving the location of the communication device associated with the user upon determining that the second endpoint is associated with an emergency service provider.

In some aspects, the techniques described herein relate to a communication endpoint, wherein the instructions to perform receiving of the location further include instructions to perform determining the communication device is available via the second network and, in response, querying the communication device for the location.

In some aspects, the techniques described herein relate to a communication endpoint, wherein the location is determined by triangulation of a plurality of radio frequency signals each in communication with the communication device.

In some aspects, the techniques described herein relate to a communication endpoint, wherein the location is determined by the communication device by receipt of global satellite positioning information.

In some aspects, the techniques described herein relate to a conference server, including: a network interface to a network; and at least one processor coupled to a computer memory including instructions that, when read by the at least one processor, cause the at least one processor to perform: accessing a conference between a first endpoint and a second endpoint, the first endpoint being shared between a plurality of users wherein images of the plurality of users are received by the first endpoint, converted to electronic signals, and provided to the second endpoint as a video portion of the conference; determining an identifier of a first user of the plurality of users; and annotating the conference presented to the second endpoint with the identifier of the first user.

In some aspects, the techniques described herein relate to a conference server, wherein annotating the conference includes annotating the video portion of the conference with at least one of a highlight, a graphical element, or a textual description of the identifier.

In some aspects, the techniques described herein relate to a conference server, wherein annotating the conference includes annotating an audio portion of the conference with generated speech announcing the identifier.

In some aspects, the techniques described herein relate to a conference server, further including: a storage device; and wherein the instructions further cause the at least one processor to perform: appending a transcript of the conference with the identifier; and storing the appended transcript in the storage device.

In some aspects, the techniques described herein relate to a conference server, further including instructions to cause the at least one processor to perform annotating the conference presented to the second endpoint with a graphical element emphasizing the first user upon detecting speech originating from the first user.

In some aspects, the techniques described herein relate to a conference server, wherein determining the identifier of the first user of the plurality of users further includes: selecting a set of candidate users from a database record including a set of potential users; and comparing an image of the first user to ones of the set of candidate users and selecting a best matching candidate user thereto; and setting the identifier to a name associated to the best matching candidate user.

In some aspects, the techniques described herein relate to a conference server, wherein the database record includes an employee directory.

In some aspects, the techniques described herein relate to a conference server, wherein the database record includes an invitation list to the conference.

In some aspects, the techniques described herein relate to a conference server, wherein the database record includes an artificial intelligence trained to receive images of the plurality of users, a set of candidate users, and a request to identify matches to the first user and return the identifier of the first user.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system in accordance with embodiments of the present disclosure;

FIG. 3 depicts a system in accordance with embodiments of the present disclosure;

FIG. 4 depicts a process in accordance with embodiments of the present disclosure;

FIG. 5 depicts a process in accordance with embodiments of the present disclosure;

FIG. 6 depicts a process in accordance with embodiments of the present disclosure;

FIG. 7 depicts a process in accordance with embodiments of the present disclosure; and

FIG. 8 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

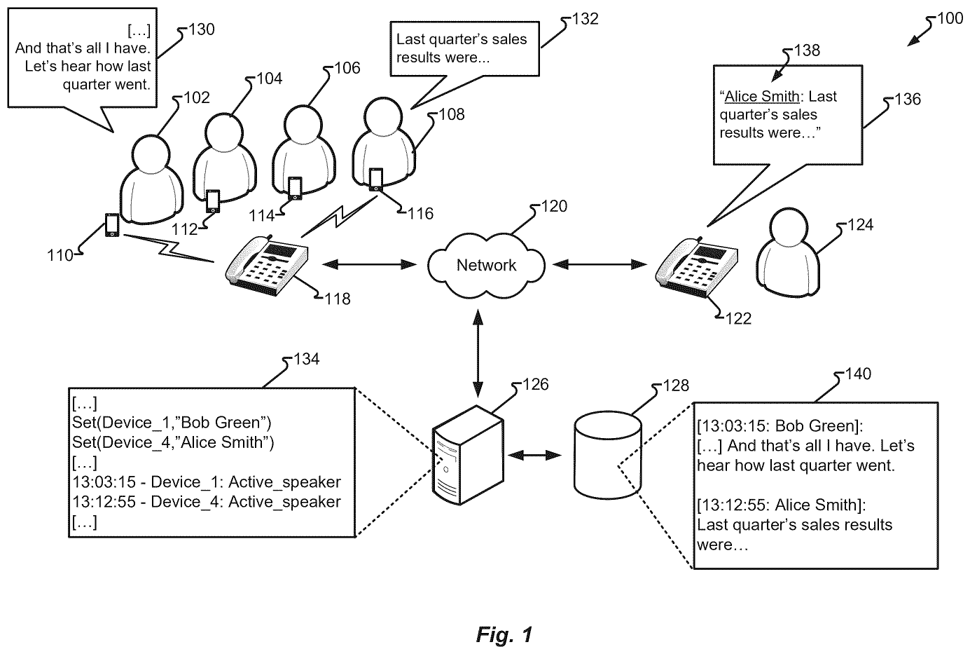

FIG. 1 depicts system 100 in accordance with embodiments of the present disclosure. In one embodiment, participants 102, 104, 106, 108, and 124 are engaged in a conference utilizing their respective participant devices, namely endpoint 118, shared by participants 102, 104, 106, and 108, and endpoint 122 used by participant 124,. to exchange encoded media, in particular audio (speech) and optionally other content, via network 120. In another embodiment, server 126 provides conferencing services which may include, but are not limited to, adding/removing attendees, encoding and broadcasting conference content, receiving conference content from any of one or more of participant devices (e.g., endpoint 118, endpoint 122, etc.) which may comprise at least a portion of the conference content, recording, transcription, and other services, such as those described in the embodiments that follow.

While participants 102, 104, 106, 108, and 124 are illustrated, it should be appreciated that the number of participants and their respective devices may be more or fewer than those illustrated when at least two endpoints (e.g., endpoint 118 and endpoint 122) are utilized and at least one endpoint is utilized by at least two participants. At least two participants, such as participant 102 and participant 108, each utilize (e.g., have on their person or nearby) a user device, such as user device 110 utilized by participant 102 and user device 116 utilized by participant 108. Other users may similarly have a user device, such as participant 104 having user device 112 and/or participant 106 having user device 114. The user devices 110, 112, 114, 116 may each be configured with “speaking detection” functionality that is operable to determine when the associated owner participant 102, 104, 106, or 108 is speaking. Speaking detection may be provided by the operating system, application, voice recognition artificial intelligence (AI) trained to recognize the owner's (participant's) speech, button press (e.g., the owner presses a button when speaking and releases the button when they finish speaking), and/or facial recognition via a camera integrated into or providing a video feed to the user device(s) 110, 112, 114, and/or 116.

In another embodiment, user devices 110, 112, 114, and 116 are not used as conference endpoints. Endpoint 118 exchanges conference content, via network 120, with endpoint 122 utilized by participant 124. Conference content comprises audio, video, documents, and/or other digitized media. However, certain embodiments provided herein focus on conference content limited to audio. For example, participant 124 may be utilizing endpoint 122 having only audio functionality (e.g., a telephone). Endpoint 122 may have video capabilities that are either disabled or unused (e.g., participant 124 is vision impaired). As a result, the current speaker heard by participant 124 may be difficult to ascertain. Accordingly, when participant 102 is speaking (e.g., speech 130), user device 110 communicates with endpoint 118 to identify participant 102 as the current speaker. The communication between user device 110 may be via Bluetooth or other communication link. When participant 108 begins to speak (e.g., speech 132), user device 116 reports participant 108 as the current speaker to endpoint 118.

In another embodiment, server 126 receives events 134 such as to register user devices, such as user device 110, associated with participant 102 (“Bob Green”), and user device 116 associated with participant 108 (“Alice Smith”). Accordingly, when any user device reports the current speaker, the user device may be readily associated with a participant. While only the start time of the current speaker is illustrated in events 134, it should be appreciated that start time, stop time, duration, absolute time, relative time, etc., may be used to determine when any particular participant beings and, optionally, ends speaking. If two or more participants are speaking at the same time, then event 134 will show overlapping starting and/or ending timestamps or similar temporal identifiers.

In another embodiment, server 126 may access or host the conference content which may further include inserting an identifier of the current speaker into the conference content for presentation by endpoint 122. For example, server 126 may provide speech 136 originating from participant 108 as speech 132 and add an identifier, such as by inserting the name (illustrated as underlined text 138 in speech 136). Additionally or alternatively, the audio feed (e.g., speech 132) received by endpoint 118 may be buffered by server 126 to accommodate an audio identifier (e.g., “Alice Smith”) being inserted into the audio portion of the conference content. The buffered audio feed is provided by server 126, rather than directly from endpoint 118, and after presentation of the audio identifier, playback of the buffered audio may be accelerated and synchronized with the real-time audio provided by endpoint 118. In another embodiment, server 126 may provide the identifier of the speaking participant as a visual identifier (e.g., text, graphic, etc.) on a display screen (not shown) of endpoint 122 and/or tactile identifier (e.g., text) on a Braille display (not shown) of endpoint 122.

In another embodiment, server 126 may comprise or utilize database 128 to maintain records of the conference. Record 140 may comprise an audio recording and/or transcription of the conference. Server 126 may annotate record 140 with the associated identifier of the speaker when detected and the associated speech. Similar to the identifier provided to endpoint 122, record 140 may be provided with generated speech, when record 140 comprises audio recording, and/or a textual identifier, when record 140 comprises a textual transcription of the conference.

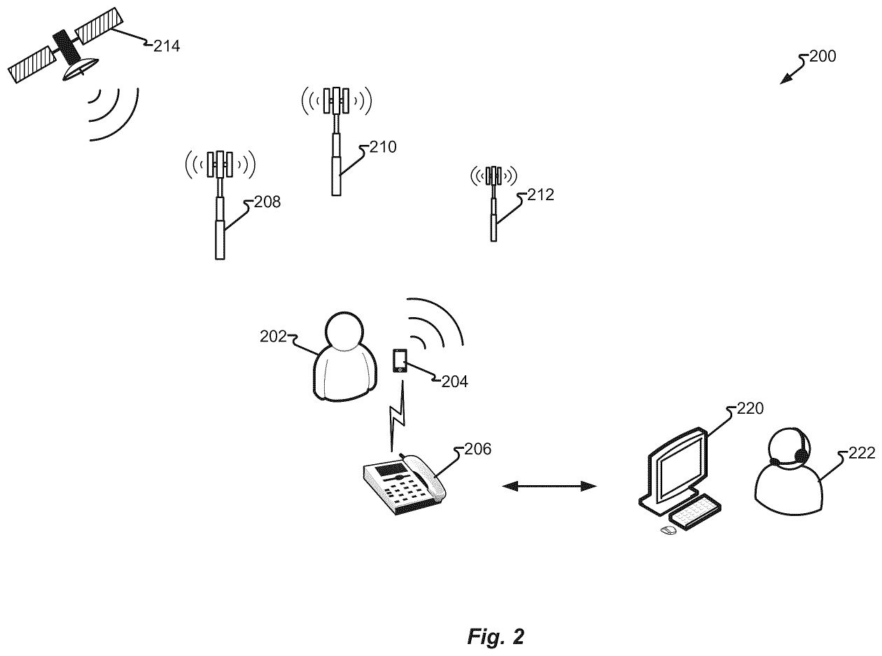

FIG. 2 depicts system 200 in accordance with embodiments of the present disclosure. In one embodiment, user 202 utilizes endpoint 206 to communicate with user 222 using endpoint 220. In one embodiment, endpoint 220 and user 222 are portions of a Public Safety Answering Point (PSAP), such as a 9-1-1, 9-9-9, 1-1-2, or similar emergency call center. User 202 may need to report an emergency situation to user 222 and be unable to report their location, such as due to impaired mental/speaking capacity due to an accident, assault, mental state, etc.; be unaware of their location; or inaccurately/erroneously report their location. Additionally, location information may not be available, such as when a user reports an emergency via text message.

In one embodiment, endpoint 220 may initiate a signal to endpoint 206 to search for, and report, any user devices in the vicinity. For example, endpoint 206 may receive the signal and determine what Bluetooth-enabled devices are nearby. If a Bluetooth-enabled device is detected, such as user device 204, a communication exchange may be initiated by endpoint 206 with user device 204 to obtain the location thereof. Due to the limited range of Bluetooth signals, user device 204 would necessarily be on or reasonably close to user 202. User device 204 may then determine its location based on signal strength to one or more cell towers, such as cell towners 208, 210, and/or 212. Additionally or alternatively, global positioning satellite(s) 214 may provide location information to user device 204. With the location information, user device 204 may then communicate the location to endpoint 206 and, in turn, endpoint 220 and user 222.

In another embodiment, user device 204 and endpoint 206 may negotiate location information that is preserved by endpoint 206. User device 204, when within communication range of endpoint 206, and/or when user 202 is utilizing endpoint 206, may provide endpoint 206 with location information. As a result, an emergency call with endpoint 220 may ask for, or be provided, location information maintained in a data memory of endpoint 206.

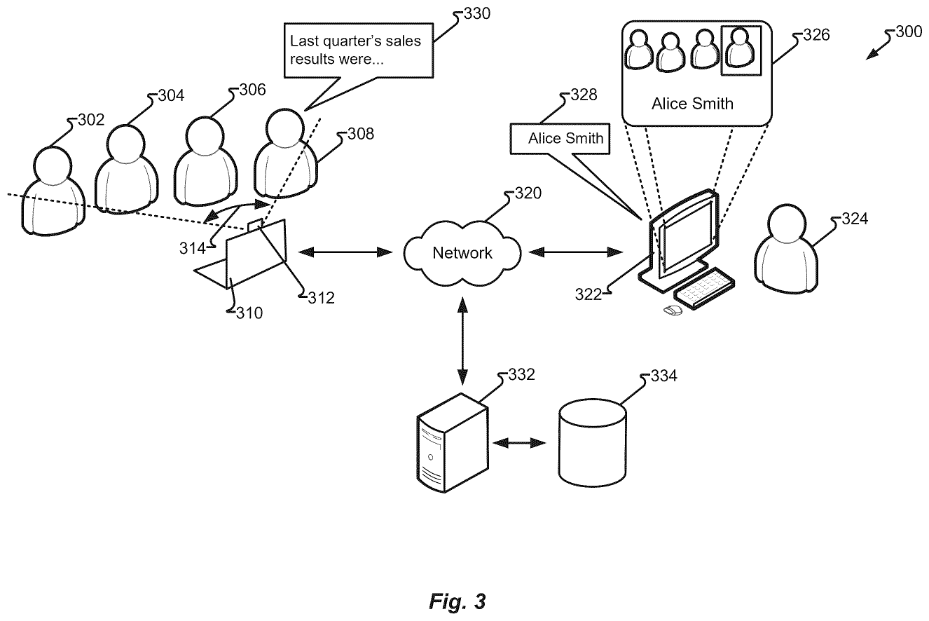

FIG. 3 depicts system 300 in accordance with embodiments of the present disclosure. In one embodiment, participants 302, 304, 306, 308 share endpoint 310 to conduct a conference, via network 320, with endpoint 322 and participant 324. Endpoint 310, such as a laptop, comprises video camera 312 having field of view 314. Field of view 314 may capture two or more participants of the conference, such as each of participants 302, 304, 306, and 308.

Participant 324 may be unaware of the identity (e.g., one or more of name, position, role, etc.) of any one or more of participants 302, 304, 306, and 308. Additionally or alternatively, participant 324 utilizing endpoint 322 may be unable to determine who is speaking at any one time. For example, endpoint 322 may be embodied as a cellular telephone having a small screen and/or network 320 may be incapable of conveying sufficient resolution to enable participant 324 to identify any one or more participants and/or the particular participant speaking at any one time.

In one embodiment, server 332 manages the conference, such as login information used for participants, via an endpoint to access the conference. When an endpoint is shared, such as endpoint 310, often only the single participant who signed in is automatically provided in the list of conference participants (not shown). For example, participant 324 may be presented with the identity of participant 302, when participant 302 used their login credentials on endpoint 310 to access the conference. The remaining participants (i.e., participants 304, 306, 308) may be unknown or otherwise known, but visually unidentifiable (e.g., due to low resolution, low bandwidth, etc.), to participant 324.

In another embodiment, endpoint 310 communicates with server 332 to determine the identity of any unidentified participants in a conference. The communication may comprise a specialized channel wherein an identifier of the conference is provided to server 332 and, in response, server 332 provides a roster of the participants. In a further embodiment, server 332 identifies the location (within a video image) of each identified participant. The identifier of the conference may be a name or other indicum, such as may be retrieved from a participant's calendar, such as a calendar application executed on endpoint 310 and/or associated with the particular participant associated with the credentials that accessed the conference.

Server 332 may access database 334, such as a calendar server, company directory, etc., to determine a likely list of attendees of the conference and a candidate list of participants. Server 332 may eliminate any participant known to be attending the conference and, therefore, already known (e.g., participant 324, participant 302, whose credentials were used to sign in to the conference, etc.). Similarly, any participant who declined to attend may be eliminated or down-weighted as a potential participant of the conference. The remaining candidate participants may then be identified on the roster of participants attending the conference.

In another embodiment, a source of candidate participant images may be obtained from an email profile, a company directory, social media, and/or other embodiment of database 334. Server 332 may then execute an image identification application to determine the particular participant and their matching identifier (e.g., name, role, title, etc.). As a result, endpoint 322 may be presented with image 326 of the conference annotated with identifiers associated with the corresponding one or more participants 302, 304, 306, and 308.

In another embodiment, when a particular participant is determined to be speaking, such as when participant 308 provides speech 330, server 332 may insert the identifier into the video stream presented by endpoint 322 (e.g., a highlighted participant with text identifying the name of the participant (e.g., “Alice Smith”)). Additionally or alternatively, server 332 may insert an audio identifier 328 for presentation by an audio speaker of endpoint 322.

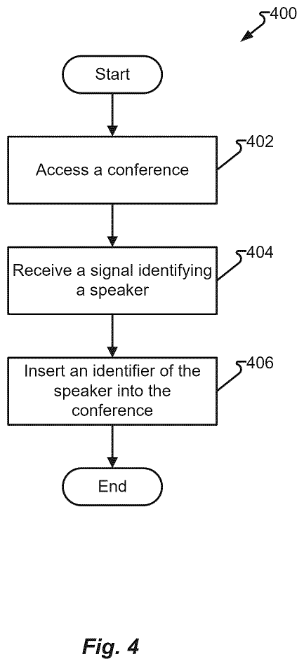

FIG. 4 depicts process 400 in accordance with embodiments of the present disclosure. In one embodiment, process 400 is embodied as machine-readable instructions maintained in a non-transitory memory that when read by a machine, such as a processor of a server, cause the machine to execute the instructions and thereby execute process 400. The processor of the server may include, but is not limited to, at least one processor of server 126.

Process 400 begins and, in step 402, a conference is accessed. The accessed conference is conducted over a network (e.g., network 120) between at least two endpoints (e.g., endpoint 118 and endpoint 122). Accessing the conference may comprise attaching a processing device, such as a conference endpoint, and/or hosting the conference via a server (e.g., server 126). Step 404 receives at one of the endpoints a signal from a communication device associated with and identifying a participant of the conference, but excludes the endpoints used for the conference. The signal may be processed by the signal receiving endpoint or forwarded on to a server (e.g., server 126). Step 406 then inserts the identifier of the speaker into the conference content for presentation by another endpoint of the conference. Additionally or alternatively, step 406 may include the identifier of the speaker in a recording and/or transcription of the conference.

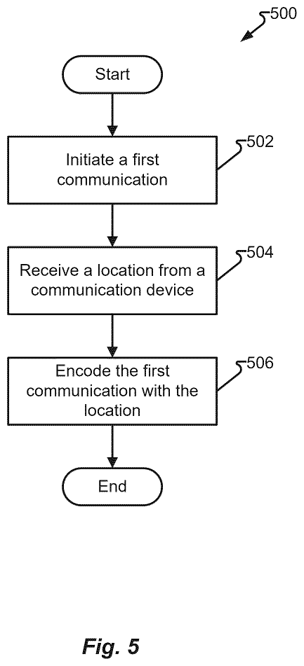

FIG. 5 depicts process 500 in accordance with embodiments of the present disclosure. In one embodiment, process 500 is embodied as machine-readable instructions maintained in a non-transitory memory that when read by a machine, such as processors of a communication device, cause the machine to execute the instructions and thereby execute process 500. The processor of the communication server may include, but is not limited to, at least one processor of endpoint 206.

In one embodiment, a first communication is accessed at step 502. Accessing may comprise initiating the first communication or joining the first communication when already established. The first communication, such as a telephone call, is conducted over a network between at least two endpoints (e.g., endpoint 206 and endpoint 220). Accessing the first communication may comprise attaching a processing device, such as a conference endpoint, and/or hosting the conference via a server. Step 504 receives, at one of the endpoints, a second communication, such as a signal from a user device (e.g., user device 204), indicating a location of the user device and, as a result, the location of the user and endpoint 206. The location of the user device may be determined via global positioning satellite(s), cell tower triangulation, and/or reference to other signals (e.g., wi-fi hubs and wireless routers). The request for the location information may be initiated by a user of the user device and/or by any one of the endpoints. Step 506 then encodes the first communication with the location information.

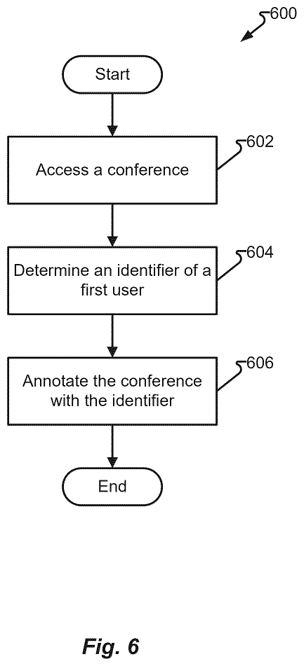

FIG. 6 depicts process 600 in accordance with embodiments of the present disclosure. In one embodiment, process 600 is embodied as machine-readable instructions maintained in a non-transitory memory that when read by a machine, such as processors of a communication device, cause the machine to execute the instructions and thereby execute process 600. The processor of the server may include, but is not limited to, at least one processor of server 332.

In one embodiment, process 600 begins and, in step 602, a conference is accessed. Accessing the conference may comprise attaching a processing device, such as a conference endpoint, and/or hosting the conference via a server (e.g., server 332). Step 604 receives at one of the endpoints, a video signal imaging a plurality of conference participants. The video signal is then analyzed to determine a roster of the conference participants. Step 604 may identify a first user of the roster and be repeated for each additional participant. The identities of the conference participants are then annotated to the conference in step 606 and provided to the receiving endpoints. The identification of the roster of conference participants may be provided by AI using image recognition. Additionally or alternatively, the roster of conference participants may be determined from a candidate list of participants (e.g., an employee directory, etc.), conference invitees, etc.

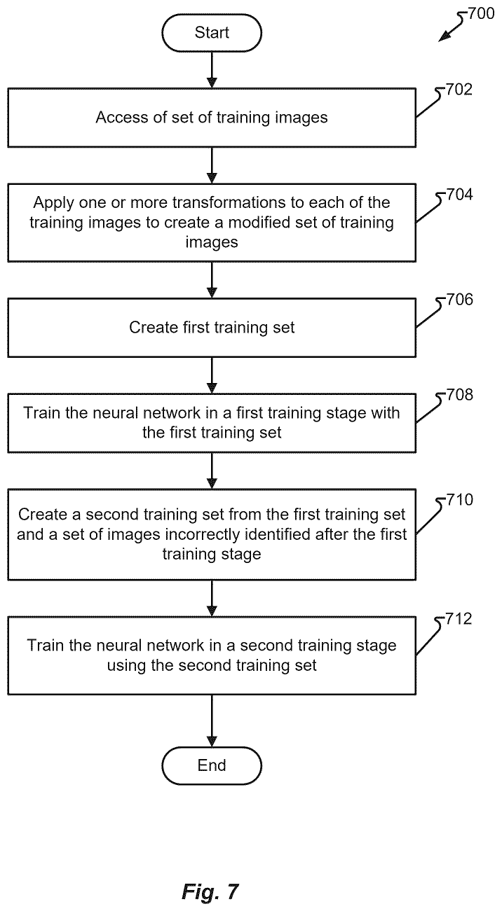

FIG. 7 depicts process 700 in accordance with embodiments of the present disclosure. In one embodiment, process 700 is embodied as machine-readable instructions maintained in a non-transitory memory that when read by a machine, such as processors of a communication device, cause the machine to execute the instructions and thereby execute process 700. The processor of the server may include, but is not limited to, at least one processor of server 332.

Process 700 may utilize a neural network. A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., a hyperplane) to delineate a combination of inputs that are active or inactive.

In one embodiment, process 700 begins and, in step 702, a set of training images is accessed. The set of training images may be selected from a larger pool of images (e.g., a company directory, social media profile, conference participant profile, etc.). Step 704 applies one more transformations to each of the set of training images to create a modified set of training images. The transformations include modifying the contrast, modifying the brightness, modifying the color saturation, rotating, adding superfluous other objects to the image, or removing superfluous other objects from the image. A first training set is then created with the set of training images and the modified set of training images in step 706. In step 708 the neural network is trained in a first training stage with the first training set.

Step 710 creates a second training set from the first training set and a set of images incorrectly identified after the first stage in training. Step 712 then trains the neural network in a second training stage with the second training set.

Once trained, the neural network may be provided with images of conference participant(s) and return an identifier (e.g., a name, position, title, etc.) of the identified conference participant(s) for inclusion in the conference and/or transcription of the conference.

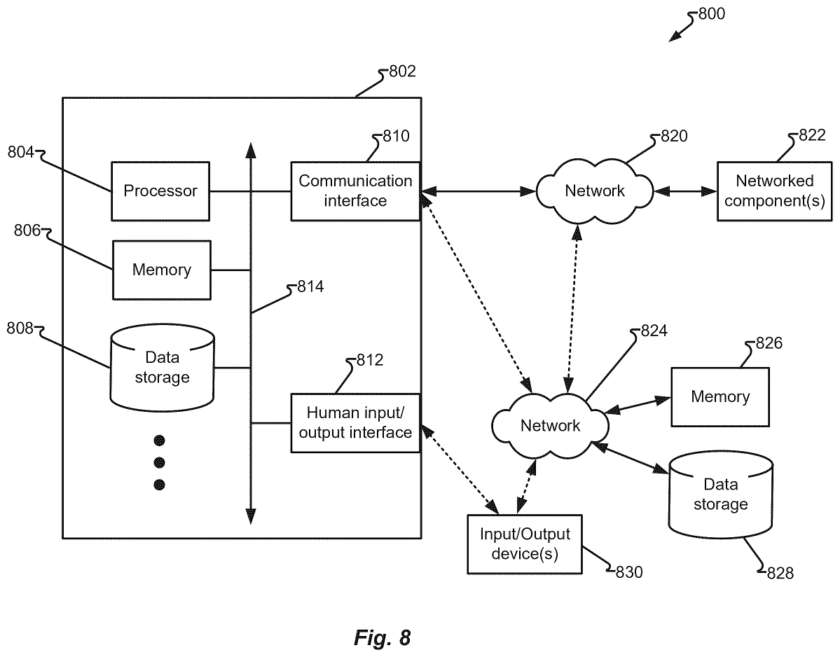

FIG. 8 depicts device 802 in system 800 in accordance with embodiments of the present disclosure. In one embodiment, one or more of endpoint 118, endpoint 122, server 126, endpoint 206, endpoint 220, endpoint 310, endpoint 322, and/or server 332 may be embodied, in whole or in part, as device 802 comprising various components and connections to other components and/or systems. The components are variously embodied and may comprise processor 804. The term “processor,” as used herein, refers exclusively to electronic hardware components comprising electrical circuitry with connections (e.g., pin-outs) to convey encoded electrical signals to and from the electrical circuitry. Processor 804 may comprise programmable logic functionality, such as determined, at least in part, from accessing machine-readable instructions maintained in a non-transitory data storage, which may be embodied as circuitry, on-chip read-only memory, computer memory 806, data storage 808, etc., that cause the processor 804 to perform the steps of the instructions. Processor 804 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 814, executes instructions, and outputs data, again such as via bus 814. In other embodiments, processor 804 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 804 is a non-transitory computing device (e.g., electronic machine comprising circuitry and connections to communicate with other components and devices). Processor 804 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 804). Processor 804 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 804, device 802 may utilize computer memory 806 and/or data storage 808 for the storage of accessible data, such as instructions, values, etc. Communication interface 810 facilitates communication with components, such as processor 804 via bus 814 with components not accessible via bus 814 and may be embodied as a network interface (e.g., ethernet card, wireless networking components, USB port, etc.). Communication interface 810 may be embodied as a network port, card, cable, or other configured hardware device. Additionally or alternatively, human input/output interface 812 connects to one or more interface components to receive and/or present information (e.g., instructions, data, values, etc.) to and/or from a human and/or electronic device. Examples of input/output devices 830 that may be connected to input/output interface include, but are not limited to, keyboard, mouse, trackball, printers, displays, sensor, switch, relay, audio speaker, microphone, still and/or video camera, etc. In another embodiment, communication interface 810 may comprise, or be comprised by, human input/output interface 812. Communication interface 810 may be configured to communicate directly with a networked component or configured to utilize one or more networks, such as network 820 and/or network 824.

Network 120 and/or network 320, may be embodied, in whole or in part, as network 820. Network 820 may be a wired network (e.g., Ethernet), wireless (e.g., WiFi, Bluetooth, cellular, etc.) network, or combination thereof and enable device 802 to communicate with networked component(s) 822. In other embodiments, network 820 may be embodied, in whole or in part, as a telephony network (e.g., public switched telephone network (PSTN), private branch exchange (PBX), cellular telephony network, etc.).

Additionally or alternatively, one or more other networks may be utilized. For example, network 824 may represent a second network, which may facilitate communication with components utilized by device 802. For example, network 824 may be an internal network to a business entity or other organization, whereby components are trusted (or at least more so) than networked components 822, which may be connected to network 820 comprising a public network (e.g., Internet) that may not be as trusted.

Components attached to network 824 may include computer memory 826, data storage 828, input/output device(s) 830, and/or other components that may be accessible to processor 804. For example, computer memory 826 and/or data storage 828 may supplement or supplant computer memory 806 and/or data storage 808 entirely or for a particular task or purpose. As another example, computer memory 826 and/or data storage 828 may be an external data repository (e.g., server farm, array, “cloud,” etc.) and enable device 802, and/or other devices, to access data thereon. Similarly, input/output device(s) 830 may be accessed by processor 804 via human input/output interface 812 and/or via communication interface 810 either directly, via network 824, via network 820 alone (not shown), or via networks 824 and 820. Each of computer memory 806, data storage 808, computer memory 826, data storage 828 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 830 may be a router, a switch, a port, or other communication component such that a particular output of processor 804 enables (or disables) input/output device 830, which may be associated with network 820 and/or network 824, to allow (or disallow) communications between two or more nodes on network 820 and/or network 824. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A conference server, comprising:
a network interface to a network; and
at least one processor coupled to a computer memory comprising instructions that, when read by the at least one processor, cause the at least one processor to perform:
accessing a conference between a first endpoint and a second endpoint, the first endpoint being shared between a plurality of users wherein speech from any one or more of the plurality of users is received by the first endpoint, converted to electronic signals, and provided to the second endpoint as an audio portion of the conference;
receiving a signal from the first endpoint identifying a user device, utilized by one of the plurality of users, and indicating speech has been detected from the one of the plurality of users; and
in response to receiving the signal, inserting an identifier into the conference for presentation by the second endpoint.

2. The conference server of claim 1, further comprising:
a storage device; and
wherein the instructions further cause the at least one processor to perform:
appending a transcript of the conference with the identifier; and
storing the appended transcript in the storage device.

3. The conference server of claim 2, further comprising appending the transcript of the conference with the identifier and a timestamp of the occurrence of the signal.

4. The conference server of claim 1, wherein inserting an identifier of the one of the plurality of users into the conference for presentation by the second endpoint comprises generating speech comprising the identifier of the one of the plurality of users.

5. The conference server of claim 4, wherein the instructions further cause the at least one processor to buffer the audio portion of the conference to accommodate presentation of the identifier by the second endpoint and, upon completion of the presentation of the identifier, resume presentation of the audio portion of the conference.

6. The conference server of claim 1, wherein the network interface further comprises a Bluetooth wireless interface and the signal further comprises a Bluetooth signal.

7. A communication endpoint, comprising:
a first network interface to a first network;
a second network interface to a second network; and
at least one processor coupled to a computer memory comprising instructions that, when read by the at least one processor, cause the at least one processor to perform:
initiating, in response to an input from a user, a first communication via the first network to a second endpoint;
receiving, via the second network interface, a location of a communication device associated with the user; and
encoding the location for inclusion in the first communication for presentation by the second endpoint.

8. The communication endpoint of claim 7, wherein receiving the location of the communication device associated with the user further comprises receiving the location of the communication device associated with the user upon determining that the second endpoint is associated with an emergency service provider.

9. The communication endpoint of claim 7, wherein the instructions to perform receiving of the location further comprise instructions to perform determining the communication device is available via the second network and, in response, querying the communication device for the location.

10. The communication endpoint of claim 7, wherein the location is determined by triangulation of a plurality of radio frequency signals each in communication with the communication device.

11. The communication endpoint of claim 7, wherein the location is determined by the communication device by receipt of global satellite positioning information.

12. A conference server, comprising:
a network interface to a network; and
at least one processor coupled to a computer memory comprising instructions that, when read by the at least one processor, cause the at least one processor to perform:
accessing a conference between a first endpoint and a second endpoint, the first endpoint being shared between a plurality of users wherein images of the plurality of users are received by the first endpoint, converted to electronic signals, and provided to the second endpoint as a video portion of the conference;
determining an identifier of a first user of the plurality of users; and
annotating the conference presented to the second endpoint with the identifier of the first user.

13. The conference server of claim 12, wherein annotating the conference comprises annotating the video portion of the conference with at least one of a highlight, a graphical element, or a textual description of the identifier.

14. The conference server of claim 12, wherein annotating the conference comprises annotating an audio portion of the conference with generated speech announcing the identifier.

15. The conference server of claim 12, further comprising:
a storage device; and
wherein the instructions further cause the at least one processor to perform:
appending a transcript of the conference with the identifier; and
storing the appended transcript in the storage device.

16. The conference server of claim 12, further comprising instructions to cause the at least one processor to perform annotating the conference presented to the second endpoint with a graphical element emphasizing the first user upon detecting speech originating from the first user.

17. The conference server of claim 12, wherein determining the identifier of the first user of the plurality of users further comprises:
selecting a set of candidate users from a database record comprising a set of potential users; and
comparing an image of the first user to ones of the set of candidate users and selecting a best matching candidate user thereto; and
setting the identifier to a name associated to the best matching candidate user.

18. The conference server of claim 17, wherein the database record comprises an employee directory.

19. The conference server of claim 17, wherein the database record comprises an invitation list to the conference.

20. The conference server of claim 17, wherein the database record comprises an artificial intelligence trained to receive images of the plurality of users, a set of candidate users, and a request to identify matches to the first user and return the identifier of the first user.
